(19) United States
(12) Patent Application Publication
(10) Pub. No.: US 2026/0140010 A1
(43) Pub. Date: May 21, 2026

(54) VIBRATION TEST COUPLING DEVICE AND FOUR-INTEGRATED VIBRATION TEST SYSTEM

(71) Applicant: Suzhou Dongling Vibration Test Instrument Co., Ltd., Suzhou, Jiangsu (CN)

(72) Inventors: Tengbo YE, Suzhou, Jiangsu (CN); Zhenwei CAO, Suzhou, Jiangsu (CN); Jinlong TANG, Suzhou, Jiangsu (CN); Xiaohong FU, Suzhou, Jiangsu (CN)

(21) Appl. No.: 19/155,931

(22) PCT Filed: May 27, 2025
(86) PCT No.: PCT/CN2025/097309

§ 371 Date: Aug. 12, 2025

(30) Foreign Application Priority Data
Aug. 22, 2024 (CN) 202411158331.8

(51) Int. Cl. G01M 7/02; F16J 15/52

(52) U.S. Cl. CPC G01M 7/027; F16J 15/52; G01M 7/022

(57) ABSTRACT

Provided are a vibration test coupling device and a four-integrated vibration test system. The vibration test coupling device includes a transition head (1), balancing assemblies (2), and a deflection correction assembly (3). The transition head (1) is slidably inserted into a test chamber (100). The transition head (1) is provided with multiple sliding channels (11). Each balancing assembly (2) includes a limiting insert plate (21) and an adjustment airbag (22). The limiting insert plate (21) is inserted into a sliding channel (11) and is connected to the test chamber (100). The adjustment airbag (22) is configured to balance a force acting on the transition head (1) under different pressure difference conditions. The deflection correction assembly (3) includes a deflection correction elastic member (31). The deflection correction elastic member (31) is configured to balance a deflection force acting on the transition head (1) due to pressure differences between different adjustment airbags (22).

### CROSS-REFERENCE TO RELATED APPLICATIONS

This is a national stage application filed under 35 U.S.C. 371 based on International Patent Application No. PCT/CN2025/097309, filed on May 27, 2025, which claims priority to Chinese Patent Application No. 202411158331.8 filed with the China National Intellectual Property Administration (CNIPA) on Aug. 22, 2024, the disclosures of which are incorporated herein by reference in their entireties.

### TECHNICAL FIELD

This application relates to the technical field of vibration testing, for example, to a vibration test coupling device and a four-integrated vibration test system.

### BACKGROUND

A four-integrated vibration test system refers to equipment capable of simultaneously conducting vibration tests under four environmental conditions of vibration, temperature, humidity, and air pressure. Conventional vibration test systems are divided into water-cooled and air-cooled types. Water-cooled vibration generators dissipate heat through independent and sealed water inlet pipelines. Therefore, the balance state of a water-cooled vibration generator can be maintained unaffected by synchronizing the air pressure changes inside the test chamber and the vibration generator. However, air-cooled vibration generators need to dissipate heat by blowing or extracting air with a fan, making it impossible to synchronize air pressure changes inside and outside the test chamber. The test chamber may experience displacement under the influence of internal and external pressures, affecting the initial balance position of the system. For a vibration test system with a maximum displacement of only 100 millimeters, this kind of displacement affects the normal operation of the equipment. In a low-pressure environment, the vibration generator operates under atmospheric pressure. When the pressure inside the test chamber is low, the pressure difference across the transition head generates an upward force of 10 tons per square meter on the transition head, pushing the transition head toward the interior of the test chamber. If this force is not balanced, the moving coil of the vibration generator shifts upward under the pressure difference, causing deflection from the balance position. Conversely, when the pressure inside the test chamber is high, the pressure difference across the transition head generates a downward force of 10 tons per square meter on the transition head, pushing the transition head away from the interior of the test chamber. If this force is not balanced, the moving coil of the vibration generator shifts downward under the pressure difference, causing deflection from the balance position.

Therefore, to ensure the stability of the position of the transition head and prevent the transition head from driving the moving coil of the vibration generator to move due to a pressure difference on the two sides, which causes the moving coil to deflect from the balance position, it is common to use the pressure changes in adjustment airbags to counteract the force acting on the transition head due to the pressure difference, maintaining the transition head in the balance position.

However, there are certain drawbacks when the adjustment airbags are used to balance the force. Due to factors such as variations in the inflation and deflation rates of individual adjustment airbags and dimensional errors among the adjustment airbags, the pressure in each adjustment airbag cannot increase or decrease synchronously when the adjustment airbags balance the force applied to the transition head. This leads to the phenomenon where the transition head tilts or deflects during adjustment due to different pressure values in the various adjusting airbags. This further prevents the central axis of the transition head from coinciding with the central axis of the vibration generator, affecting the balance position of the moving coil, damaging the vibration generator, and causing a failure in normal operation of the vibration generator.

### SUMMARY

This application provides a vibration test coupling device and a four-integrated vibration test system, which can balance the pressure difference across a transition head to keep the transition head in a balance position and can avoid deflection and tilting when a force acting on the transition head due to a pressure difference is counteracted. This ensures that the central axis of the transition head always coincides with the central axis of a vibration generator, preventing damage to the vibration generator and thereby ensuring effective operation of the vibration generator.

In one aspect, embodiments of this application provide a vibration test coupling device. The device includes a transition head, multiple balancing assemblies, and a deflection correction assembly.

The transition head is slidably inserted into a test chamber. A first end of the transition head extends into the test chamber, and a second end of the transition head extends out of the test chamber to be connected to a moving coil of a vibration generator. An outer peripheral surface of the transition head is provided with multiple sliding channels uniformly distributed along the circumferential direction.

The multiple balancing assemblies are in a one-to-one correspondence with the multiple sliding channels. Each balancing assembly includes a limiting insert plate and an adjustment airbag. A part of the limiting insert plate is inserted into a corresponding sliding channel, and the other part of the limiting insert plate extends out of the corresponding sliding channel to be connected to the test chamber. The adjustment airbag is disposed in the corresponding sliding channel and is sandwiched between the limiting insert plate and a surface of the corresponding sliding channel facing the limiting insert plate. The adjustment airbag is configured to balance forces acting on the transition head under different pressure difference conditions.

The deflection correction assembly includes a deflection correction elastic member. The deflection correction elastic member is connected in the sliding channel and is configured to balance a deflection force acting on the transition head due to pressure differences between different adjustment airbags.

In some embodiments, the deflection correction assembly also includes a first connecting member and a second connecting member, the first connecting member is connected to a surface of the limiting insert plate that is connected to the adjustment airbag, the second connecting member is connected to a sidewall of the sliding channel, and two ends of the deflection correction elastic member are connected to the first connecting member and the second connecting member, respectively.

In some embodiments, each sliding channel is provided with multiple symmetrically distributed deflection correction assemblies.

In some embodiments, the vibration test coupling device also includes a support connecting ring, the test chamber is provided with a through-hole for insertion of the transition head, the support connecting ring is connected at the through-hole, the transition head is slidably inserted into the support connecting ring, and the part of the limiting insert plate extending out of the sliding channel is connected to the support connecting ring.

In some embodiments, the vibration test coupling device also includes a sealing assembly, the sealing assembly includes a sealing member, and the sealing member is sleeved on the transition head and is configured to seal a gap between the transition head and the support connecting ring.

In some embodiments, the sealing assembly also includes a fixing ring, the fixing ring is connected to a side of the support connecting ring facing away from the limiting insert plate, and the sealing member is sandwiched between an inner side of the fixing ring and an outer side of the transition head.

In some embodiments, the limiting insert plate includes an insertion portion and a connecting portion, the insertion portion is inserted into the sliding channel and is adapted to the shape of the sliding channel, the connecting portion is disposed outside the sliding channel and extends in a direction away from the adjustment airbag, and the connecting portion is connected to the support connecting ring.

In some embodiments, each sliding channel is a sector-shaped notch opened on the transition head, and the insertion portion is a triangle cooperating with the sector-shaped notch.

In some embodiments, a threaded connecting hole is opened at the through-hole of the test chamber, and the support connecting ring is provided with a double-ended countersunk hole corresponding to the threaded connecting hole.

In another aspect, embodiments of this application provide a four-integrated vibration test system. The four-integrated vibration test system includes the vibration test coupling device according to any of the preceding embodiments, the vibration generator, the test chamber, and a test platform. The vibration generator is configured to provide a vibration environment for a vibration test. The test chamber is configured to provide a test specimen with temperature, humidity, a low-pressure environment, and a high-pressure environment. The test platform is disposed in the test chamber and is connected to the end of the transition head extending into the test chamber. The test platform is configured to carry the test specimen.

### BRIEF DESCRIPTION OF DRAWINGS

FIG. 1 is an assembly view of a vibration test coupling device according to this application.

FIG. 2 is a structural sectional view of a vibration test coupling device according to this application.

FIG. 3 is a view illustrating the connection of a vibration test coupling device when the interior of a test chamber is in a low-pressure environment according to this application.

FIG. 4 is a view illustrating the connection of a vibration test coupling device when the interior of a test chamber is in a high-pressure environment according to this application.

FIG. 5 is a state view of a deflection correction elastic member of a vibration test coupling device when the deflection correction elastic member is not subjected to a force according to this application.

FIG. 6 is a state view of a deflection correction elastic member of a vibration test coupling device when the deflection correction elastic member is subjected to a force according to this application.

### REFERENCE LIST

100 test chamber
101 through-hole
1011 threaded connecting hole
102 fixing boss
200 vibration generator
201 moving coil
300 test platform
1 transition head
11 sliding channel
2 balancing assembly
21 limiting insert plate
211 insertion portion
212 connecting portion
22 adjustment airbag
3 deflection correction assembly
31 deflection correction elastic member
32 first connecting member
33 second connecting member
4 support connecting ring
41 double-ended countersunk hole
5 sealing assembly
51 sealing member
52 fixing ring

### DETAILED DESCRIPTION

Hereinafter this application is described in conjunction with drawings and embodiments. The embodiments described herein are used to explain this application. For ease of description, only parts of the structure related to this application are shown in the drawings.

In the description of this application, unless otherwise expressly specified and limited, a term “connected to each other”, “connected”, or “secured” is to be construed in a broad sense, for example, as securely connected, detachably connected, or integrated; mechanically connected or electrically connected; directly connected to each other or indirectly connected to each other via an intermediary; or internally connected between two components or interaction relations between two components. For those of ordinary skill in the art, meanings of the preceding terms in this application can be understood according to situations.

In this application, unless otherwise expressly specified and limited, when a first feature is described as “above” or “below” a second feature, the first feature and the second feature may be in direct contact or be in contact via another feature between the two features instead of being in direct contact. Moreover, when the first feature is “on”, “above”, or “over” the second feature, the first feature is right on, above, or over the second feature, or the first feature is obliquely on, above, or over the second feature, or the first feature is at a higher level than the second feature. When the first feature is “under”, “below”, or “underneath” the second feature, the first feature is right under, below, or underneath the second feature, or the first feature is obliquely under, below, or underneath the second feature, or the first feature is at a lower level than the second feature.

In the description of the embodiments, orientations or position relations indicated by terms such as “above”, “below”, and “right” are based on the drawings. These orientations or position relations are intended only to facilitate the description and simplify an operation and not to indicate or imply that a device or element referred to must have such particular orientations or must be configured or operated in such particular orientations. In addition, terms “first” and “second” are used only to distinguish between descriptions and have no special meaning.

A four-integrated vibration test system refers to equipment capable of simultaneously conducting vibration tests under four environmental conditions of vibration, temperature, humidity, and air pressure. Conventional vibration test systems are divided into water-cooled and air-cooled types. Water-cooled vibration generators dissipate heat through independent and sealed water inlet pipelines. Therefore, the balance state can be maintained unaffected by synchronizing the air pressure changes inside the test chamber and the vibration generator. However, air-cooled vibration generators need to dissipate heat by blowing or extracting air with a fan, making it impossible to synchronize air pressure changes inside and outside the test chamber. The test chamber may experience displacement under the influence of internal and external pressures, affecting the initial balance position of the system. For a vibration test system with a maximum displacement of only 100 millimeters, this affects normal operation of the equipment. In a low-pressure environment, the vibration generator operates under atmospheric pressure. When the pressure of the interior of the test chamber is low, the pressure difference across the transition head generates an upward force of 10 tons per square meter on the transition head, pushing the transition head toward the interior of the test chamber. If this force is not balanced, the moving coil of the vibration generator shifts upward under the pressure difference, causing deflection from the balance position. Conversely, when the pressure of the interior of the test chamber is high, the pressure difference across the transition head generates a downward force of 10 tons per square meter on the transition head, pushing the transition head away from the interior of the test chamber. If this force is not balanced, the moving coil of the vibration generator shifts downward under the pressure difference, causing deflection from the balance position.

Therefore, to ensure the stability of the position of the transition head and prevent the transition head from driving the moving coil of the vibration generator to move due to pressure differences on two sides, which causes the moving coil to deflect from the balance position, it is common to use the pressure changes in adjustment airbags to counteract the force acting on the transition head due to a pressure difference, maintaining the transition head in a balance position.

However, certain drawbacks exist when the adjustment airbags are used to balance the force. Due to factors such as variations in the inflation and deflation rates of individual adjustment airbags and dimensional errors among the adjustment airbags, the pressure in each adjustment airbag cannot increase or decrease synchronously when the adjustment airbags balance the force applied to the transition head. This leads to the phenomenon where the transition head deflects or tilts during adjustment due to different pressure values in the various adjusting airbags. This further prevents the central axis of the transition head from coinciding with the central axis of the vibration generator, affecting the balance position of the moving coil, damaging the vibration generator, and causing a failure in the normal operation of the vibration generator.

Therefore, the embodiment provides a vibration test coupling device to balance the pressure difference across the transition head to keep the transition head in a balance position and avoid deflection and tilting due to pressure differences in various adjustment airbags when a force acting on the transition head due to the pressure difference is counteracted. In this manner, it is ensured that the central axis of the transition head always coincides with the central axis of the vibration generator, preventing damage to the vibration generator and ensuring effective operation of the vibration generator.

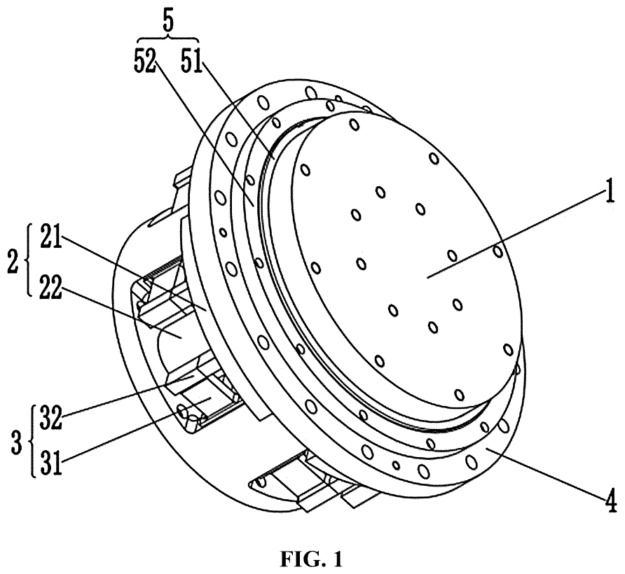

As shown in FIG. 1 to FIG. 6, the vibration test coupling device includes a transition head 1, balancing assemblies 2, and a deflection correction assembly 3; the transition head 1 is slidably inserted into a test chamber 100, a first end of the transition head 1 extends into the test chamber 100, a second end of the transition head 1 extends out of the test chamber 100 to be connected to a moving coil 201 of a vibration generator 200, and an outer peripheral surface of the transition head 1 is provided with multiple sliding channels 11 uniformly distributed along the circumferential direction. The multiple balancing assemblies 2 are in a one-to-one correspondence with the multiple sliding channels 11, each balancing assembly 2 includes a limiting insert plate 21 and an adjustment airbag 22, a part of the limiting insert plate 21 is inserted into a corresponding sliding channel 11, the other part of the limiting insert plate 21 extends out of the corresponding sliding channel 11 to be connected to the test chamber 100, the adjustment airbag 22 is disposed in the corresponding sliding channel 11 and is sandwiched between the limiting insert plate 21 and a surface of the corresponding sliding channel 11 facing the limiting insert plate 21, and the adjustment airbag 22 is configured to balance forces acting on the transition head 1 under different pressure difference conditions. The deflection correction assembly 3 includes a deflection correction elastic member 31, and the deflection correction elastic member 31 is connected in a corresponding sliding channel 11 and is configured to balance a deflection force acting on the transition head 1 due to a pressure difference between different adjustment airbags 22.

In some embodiments, at least one deflection correction assembly 3 is disposed in each sliding channel 11, a first end of the deflection correction elastic member 31 of each deflection correction assembly 3 is connected to a surface of the limiting insert plate 21 located in the corresponding sliding channel 11, and a second end of the deflection correction elastic member 31 of each deflection correction assembly 3 is connected to a sidewall of the corresponding sliding channel 11. When the adjustment airbag 22 causes the limiting insert plate 21 to shift due to uneven pressure, the deflection correction elastic member 31 can be driven to deform so that the deflection force caused by the uneven pressure in the adjustment airbag 22 can be counteracted by utilizing the elastic restoring force of the deflection correction elastic member 31.

The adjustment airbag 22 is disposed in each sliding channel 11 on the transition head 1, two ends of each adjustment airbag 22 are connected to the limiting insert plate 21 and the surface of the sliding channel 11 facing the limiting insert plate 21, respectively, and the limiting insert plate 21 is connected to the test chamber 100. In this manner, when a pressure difference exists between the interior of the test chamber 100 and the external environment, the adjustment airbag 22 is inflated to increase the internal pressure of the adjustment airbag 22, thereby balancing the force acting on the transition head 1 due to the pressure difference on two sides and maintaining the transition head 1 in a balance position. Additionally, the deflection correction elastic member 31 is disposed in the sliding channel 11 so that when the transition head 1 deflects or tilts due to pressure differences among different adjustment airbags 22, the deflection correction elastic member 31 deforms, and the elastic force of the deflection correction elastic member 31 is used to counteract the deflection and tilt force acting on the transition head 1 due to the pressure differences among different adjustment airbags 22. This ensures that the central axis of the transition head 1 always coincides with the central axis of the vibration generator 200, thereby preventing the moving coil 201 from deflecting and tilting with the transition head 1 and thus from causing damage to the vibration generator 200, and ensuring effective operation of the vibration generator 200.

When the interior of the test chamber 100 is in a low-pressure environment, the external atmospheric pressure exceeds the internal pressure of the test chamber 100. Therefore, the transition head 1 experiences a thrust that pushes the transition head 1 deeper into the test chamber 100. In this case, the adjustment airbag 22 is inflated to increase the internal pressure value of the adjustment airbag 22 and maintain the distance between the limiting insert plate 21 and the surface of the sliding channel 11 facing the limiting insert plate 21 unchanged, thereby stabilizing the transition head 1 and maintaining the transition head 1 in the balance position. Moreover, due to variations in the inflation rates of individual adjustment airbags 22, dimensional errors among the adjustment airbags 22, and other factors, the transition head 1 experiences a deflection and tilt force due to pressure differences among different adjustment airbags 22, the deflection correction elastic member 31 deforms, and the elastic force of the deflection correction elastic member 31 is used to counteract the deflection and tilt force acting on the transition head 1 due to the pressure differences among different adjustment airbags 22. This ensures that the central axis of the transition head 1 always coincides with the central axis of the vibration generator 200 to ensure effective operation of the vibration generator 200.

When the interior of the test chamber 100 is in a high-pressure environment, the external atmospheric pressure is lower than the internal pressure of the test chamber 100. Therefore, the transition head 1 experiences a traction force that pulls the transition head 1 away from the interior of the test chamber 100. In this case, the adjustment airbag 22 is deflated to decrease the internal pressure value of the adjustment airbag 22 and maintain the distance between the limiting insert plate 21 and the surface of the sliding channel 11 facing the limiting insert plate 21 unchanged, thereby stabilizing the transition head 1 and maintaining the transition head 1 in the balance position. Moreover, due to variations in the inflation rates of individual adjustment airbags 22, dimensional errors among the adjustment airbags 22, and other factors, the transition head 1 experiences a deflection and tilt force due to pressure differences among different adjustment airbags 22, the deflection correction elastic member 31 deforms, and the elastic force of the deflection correction elastic member 31 is used to counteract the deflection and tilt force acting on the transition head 1 due to the pressure differences among different adjustment airbags 22. This ensures that the central axis of the transition head 1 always coincides with the central axis of the vibration generator 200 to ensure effective operation of the vibration generator 200.

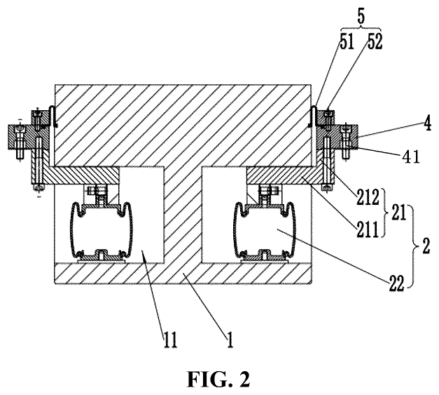

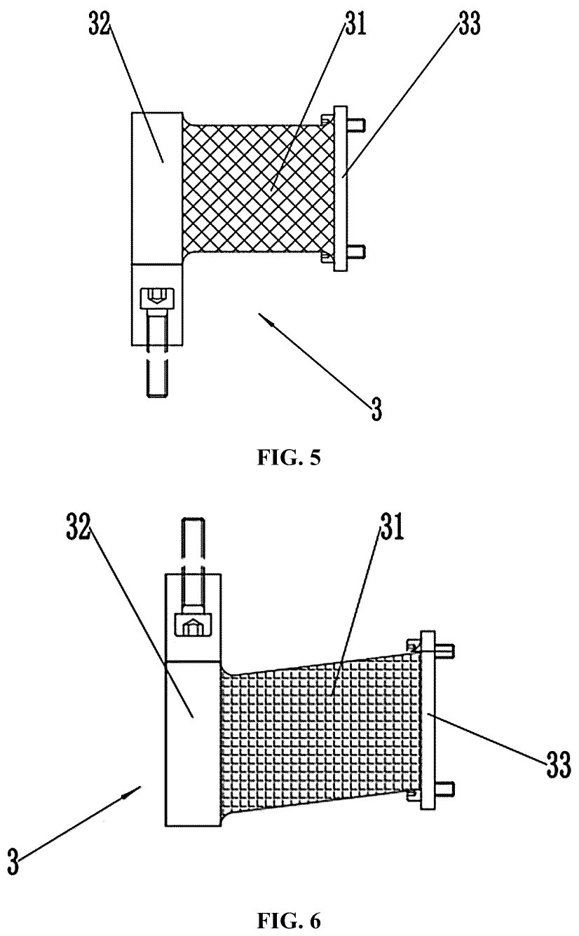

As shown in FIG. 2 and FIG. 5, the deflection correction assembly 3 also includes a first connecting member 32 and a second connecting member 33, the first connecting member 32 is connected to the surface of the limiting insert plate 21 that is connected to the adjustment airbag 22, the second connecting member 33 is connected to the sidewall of the sliding channel 11, and two ends of the deflection correction elastic member 31 are connected to the first connecting member 32 and the second connecting member 33, respectively. Via the first connecting member 32, the first end of the deflection correction elastic member 31 is connected to the surface of the limiting insert plate 21 that is connected to the adjustment airbag 22, and via the second connecting member 33, the second end of the deflection correction elastic member 31 is connected to the sidewall of the sliding channel 11. In this manner, the deflection correction elastic member 31 forms a force mode similar to a cantilever beam. That is, when the end of the deflection correction elastic member 31 connected to the first connecting member 32 is subjected to force, even if the deflection and tilt amplitude is small, the deflection correction elastic member 31 undergoes a large deformation, thereby responding promptly, generating a large elastic force through the large deformation to counteract the deflection and tilt force acting on the transition head 1 due to pressure differences among different adjustment airbags 22, and ensuring that the central axis of the transition head 1 always coincides with the central axis of the vibration generator 200.

In this embodiment, the first connecting member 32 is rod-shaped and connected to the limiting insert plate 21 by bolts, and the second connecting member 33 is plate-shaped and connected to the sidewall of the sliding channel 11 by bolts. In this embodiment, the deflection correction elastic member 31 may be any elastic component, such as a rubber plate or a spring mesh.

In one or more embodiments, as shown in FIG. 1, each sliding channel 11 includes multiple symmetrically distributed deflection correction assemblies 3. By the disposition of multiple deflection correction assemblies 3 in each sliding channel 11, sufficient force is ensured during deflection correction. In this embodiment, each sliding channel 11 includes two deflection correction assemblies 3, and the deflection correction elastic members 31 of the two deflection correction assemblies 3 are arranged at an angle to each other, thereby providing better force distribution when the deflection and tilt force acting on the transition head 1 due to pressure differences among different adjustment airbags 22 is counteracted and enhancing the force for deflection correction.

In one or more embodiments, as shown in FIG. 2, the vibration test coupling device also includes a support connecting ring 4. The test chamber 100 is provided with a through-hole 101 for insertion of the transition head 1. The support connecting ring 4 is connected at the through-hole 101. The transition head 1 is slidably inserted into the support connecting ring 4. The part of the limiting insert plate 21 extending out of the sliding channel 11 is connected to the support connecting ring 4. By the disposition of the support connecting ring 4, a sliding connection between the test chamber 100 and the transition head 1 is achieved. In this embodiment, the inner wall of the through-hole 101 extends toward the center of the through-hole 101 to form a fixing boss 102, thereby providing a connection position for the support connecting ring 4. Since the fixing boss 102 is formed on the inner wall of the through-hole 101 of the test chamber 100, mounting slots on two sides of the fixing boss 102 are formed on the test chamber 100. When the support connecting ring 4 is connected to the fixing boss 102, the support connecting ring 4 is accommodated in the mounting slots so that the support connecting ring 4 overlaps spatially with the test chamber 100. Thus, protrusion of the support connecting ring 4 beyond the surface of the test chamber 100 is avoided, without an additional space occupied by the support connecting ring 4, and the structure is made more compact.

In one or more embodiments, as shown in FIG. 2, the vibration test coupling device also includes a sealing assembly 5, the sealing assembly 5 includes a sealing member 51, and the sealing member 51 is sleeved on the transition head 1 and is configured to seal a gap between the transition head 1 and the support connecting ring 4. Since the transition head 1 is slidably inserted into the support connecting ring 4, a gap exists between the transition head 1 and the support connecting ring 4. By the disposition of the sealing member 51, the gap between the transition head 1 and the support connecting ring 4 is sealed, ensuring the airtightness of the test chamber 100. In this embodiment, the sealing member 51 is made of materials such as nitrile rubber or silicone rubber to adapt to different media and operating conditions.

In one or more embodiments, as shown in FIG. 2, the sealing assembly 5 also includes a fixing ring 52, the fixing ring 52 is connected to a side of the support connecting ring 4 facing away from the limiting insert plate 21, and the sealing member 51 is sandwiched between an inner side of the fixing ring 52 and an outer side of the transition head 1. The fixing ring 52 is connected to the support connecting ring 4, and the sealing member 51 is sandwiched between the inner side of the fixing ring 52 and the outer side of the transition head 1 so that the sealing member 51 can be replaced by removing the fixing ring 52 without disassembling the support connecting ring 4, making the replacement of the sealing member 51 more convenient. In this embodiment, the fixing ring 52 is provided with a countersunk hole, and the support connecting ring 4 is provided with a threaded connecting hole 1011 that is in a one-to-one correspondence with the countersunk hole on the fixing ring 52. Bolts are threadedly connected to the threaded connecting hole 1011 on the support connecting ring 4 by passing through the countersunk hole on the fixing ring 52.

In this embodiment, the sealing member 51 has a U-shaped cross-section, and the two ends of the sealing member 51 are trapezoidal. Moreover, dovetail grooves are respectively opened on the support connecting ring 4 and the transition head 1 so that the two trapezoidal ends of the sealing member 51 can be engaged in the dovetail grooves on the support connecting ring 4 and the transition head 1, respectively, thereby achieving fixation of the sealing member 51. By cooperation with the fixing ring 52, the sealing member 51 is pressed tightly against the transition head 1, ensuring sealing reliability.

In one or more embodiments, as shown in FIG. 2, the limiting insert plate 21 includes an insertion portion 211 and a connecting portion 212, the insertion portion 211 is inserted into the corresponding sliding channel 11 and is adapted to the shape of the corresponding sliding channel 11, the connecting portion 212 is disposed outside the corresponding sliding channel 11 and extends in a direction away from the adjustment airbag 22, and the connecting portion 212 is connected to the support connecting ring 4. By the disposition of the insertion portion 211 adapted to the shape of the sliding channel 11, the limiting insert plate 21 fits more closely with the transition head 1 after being inserted into the sliding channel 11, increasing the contact area and enhancing the limiting force of the limiting insert plate 21 on the transition head 1.

In one or more embodiments, as shown in FIG. 1, the sliding channel 11 is a sector-shaped notch opened on the transition head 1, and the insertion portion 211 is a triangle cooperating with the sector-shaped notch. By the disposition of a sector-shaped notch, sufficient installation space is provided for the balancing assembly 2 and the deflection correction assembly 3 while as much material as possible is retained on the transition head 1, thereby ensuring that the structural strength of the transition head 1 meets the requirements of the vibration test.

In one or more embodiments, as shown in FIG. 2, a threaded connecting hole 1011 is opened at the through-hole 101 of the test chamber 100, and the support connecting ring 4 is provided with a double-ended countersunk hole 41 corresponding to the threaded connecting hole 1011. The double-ended countersunk hole 41 is opened on the support connecting ring 4. In this manner, on one hand, the support connecting ring 4 can be connected to the test chamber 100 with countersunk bolts regardless of orientation, thereby improving convenience of the connection of the support connecting ring 4; on the other hand, when the support connecting ring 4 is connected using countersunk bolts, the countersunk bolts do not protrude from the surface of the support connecting ring 4, thereby ensuring flatness of the surface of the support connecting ring 4. In this embodiment, since the support connecting ring 4 is fixedly connected to the fixing boss 102, the threaded connecting hole 1011 is disposed on the fixing boss 102 and passes through the fixing boss 102.

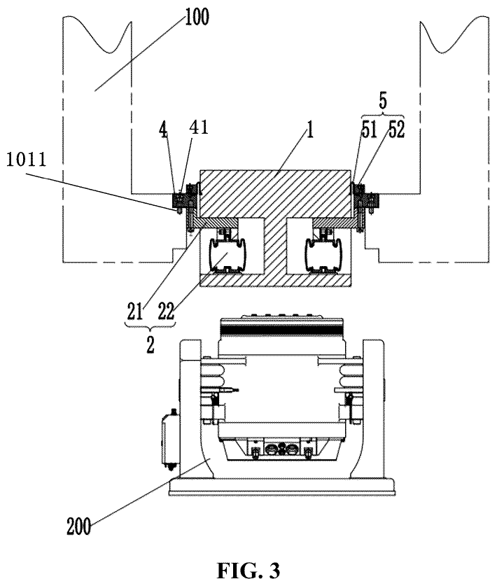

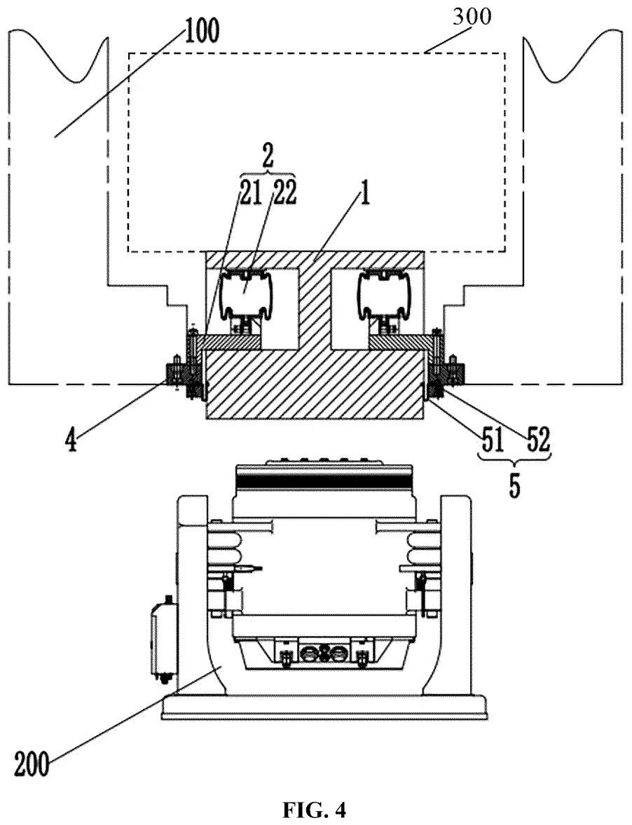

In some embodiments, since the adjustment airbag 22 can only withstand pressure and cannot resist tension, when the interior of the test chamber 100 is in different pressure environments, the position of the adjustment airbag 22 needs to be adjusted to ensure that the adjustment airbag 22 is subjected only to thrust. This vibration test coupling device is used as an example. As shown in FIG. 3, when the interior of the test chamber 100 is in a low-pressure environment, the limiting insert plate 21 abuts against the side of the sliding channel 11 close to the test chamber 100, and the adjustment airbag 22 is located on the side of the limiting insert plate 21 facing the vibration generator 200. As shown in FIG. 4, when the interior of the test chamber 100 is in a high-pressure environment, the limiting insert plate 21 abuts against the side of the sliding channel 11 close to the vibration generator 200, and the adjustment airbag 22 is located on the side of the limiting insert plate 21 facing the test chamber 100. Therefore, in this vibration test coupling device, the support connecting ring 4 that can be connected to the test chamber 100 regardless of orientation is provided so that when the pressure environment inside the test chamber 100 changes, it is not required to adjust the position of the adjustment airbag 22. By using the support connecting ring 4 to achieve a reversed connection of the vibration test coupling device, vibration tests under different pressure environments can be adapted.

In this embodiment, a four-integrated vibration test system is also provided. The four-integrated vibration test system includes the vibration test coupling device described above, the vibration generator 200, the test chamber 100, and a test platform 300. The vibration generator 200 is configured to provide a vibration environment for the vibration test. The test chamber 100 is configured to provide a test specimen with temperature, humidity, a low-pressure environment, and a high-pressure environment. The test platform 300 is disposed in the test chamber 100 and is connected to the end of the transition head 1 extending into the test chamber 100. The test platform 300 is configured to carry the test specimen.

By applying the preceding vibration test coupling device, this four-integrated vibration test system can consistently maintain the transition head 1 in a balance position while preventing deflection and tilting of the transition head 1, thereby ensuring effective testing of the four-integrated vibration system under any variable pressure environment.

1. A vibration test coupling device, comprising:
a transition head, wherein the transition head is slidably inserted into a test chamber, a first end of the transition head extends into the test chamber, a second end of the transition head extends out of the test chamber to be connected to a moving coil of a vibration generator, and a plurality of sliding channels are formed on an outer peripheral surface of the transition head and are uniformly distributed along a circumferential direction of the transition head;
a plurality of balancing assemblies, wherein the plurality of balancing assemblies are in a one-to-one correspondence with the plurality of sliding channels, each balancing assembly of the plurality of balancing assemblies comprises a limiting insert plate and an adjustment airbag, a part of the limiting insert plate is inserted into a corresponding sliding channel of the plurality of sliding channels, the other part of the limiting insert plate extends out of the corresponding sliding channel to be connected to the test chamber, the adjustment airbag is disposed in the corresponding sliding channel and is sandwiched between the limiting insert plate and a surface of the corresponding sliding channel facing the limiting insert plate and the adjustment airbag is configured to balance forces acting on the transition head under different pressure difference conditions; and
a deflection correction assembly, wherein the deflection correction assembly comprises a deflection correction elastic member, and the deflection correction elastic member is connected in a sliding channel of the plurality of sliding channels and is configured to balance a deflection force acting on the transition head due to a pressure difference between different adjustment airbags;
wherein the deflection correction assembly further comprises a first connecting member and a second connecting member, the first connecting member is connected to a surface of the limiting insert plate that is connected to the adjustment airbag, the second connecting member is connected to a sidewall of the corresponding sliding channel, and two ends of the deflection correction elastic member are connected to the first connecting member and the second connecting member, respectively.

2. (canceled)

3. The vibration test coupling device according to claim 1, wherein each sliding channel of the plurality of sliding channels is provided with a plurality of symmetrically distributed deflection correction assemblies.

4. The vibration test coupling device according to claim 1, further comprising a support connecting ring, wherein the test chamber is provided with a through-hole for insertion of the transition head, the support connecting ring is connected at the through-hole, the transition head is slidably inserted into the support connecting ring, and the part of the limiting insert plate extending out of the corresponding sliding channel is connected to the support connecting ring.

5. The vibration test coupling device according to claim 4, further comprising a sealing assembly, wherein the sealing assembly comprises a sealing member, and the sealing member is sleeved on the transition head and is configured to seal a gap between the transition head and the support connecting ring.

6. The vibration test coupling device according to claim 5, wherein the sealing assembly further comprises a fixing ring, the fixing ring is connected to a side of the support connecting ring facing away from the limiting insert plate, and the sealing member is sandwiched between an inner side of the fixing ring and an outer side of the transition head.

7. The vibration test coupling device according to claim 4, wherein the limiting insert plate comprises an insertion portion and a connecting portion, the insertion portion is inserted into the corresponding sliding channel and is adapted to a shape of the corresponding sliding channel, the connecting portion is disposed outside the corresponding sliding channel and extends in a direction away from the adjustment airbag, and the connecting portion is connected to the support connecting ring.

8. The vibration test coupling device according to claim 7, wherein each of the plurality of sliding channels is a sector-shaped notch opened on the transition head, and the insertion portion is a triangle cooperating with the sector-shaped notch.

9. The vibration test coupling device according to claim 4, wherein a threaded connecting hole is opened at the through-hole of the test chamber, and the support connecting ring is provided with a double-ended countersunk hole corresponding to the threaded connecting hole.

10. A four-integrated vibration test system, comprising a vibration test coupling device, a vibration generator, a test chamber, and a test platform,
wherein the vibration test coupling device comprises:
a transition head, wherein the transition head is slidably inserted into the test chamber, a first end of the transition head extends into the test chamber, a second end of the transition head extends out of the test chamber to be connected to a moving coil of the vibration generator, and a plurality of sliding channels are formed on an outer peripheral surface of the transition head and are uniformly distributed along a circumferential direction of the transition head;
a plurality of balancing assemblies, wherein the plurality of balancing assemblies are in a one-to-one correspondence with the plurality of sliding channels, each balancing assembly of the plurality of balancing assemblies comprises a limiting insert plate and an adjustment airbag, a part of the limiting insert plate is inserted into a corresponding sliding channel of the plurality of sliding channels, the other part of the limiting insert plate extends out of the corresponding sliding channel to be connected to the test chamber, the adjustment airbag is disposed in the corresponding sliding channel and is sandwiched between the limiting insert plate and a surface of the corresponding sliding channel facing the limiting insert plate, and the adjustment airbag is configured to balance forces acting on the transition head under different pressure difference conditions; and
a deflection correction assembly, wherein the deflection correction assembly comprises a deflection correction elastic member, and the deflection correction elastic member is connected in a sliding channel of the plurality of sliding channels and is configured to balance a deflection force acting on the transition head due to a pressure difference between different adjustment airbags;
wherein the deflection correction assembly further comprises a first connecting member and a second connecting member, the first connecting member is connected to a surface of the limiting insert plate that is connected to the adjustment airbag, the second connecting member is connected to a sidewall of the corresponding sliding channel, and two ends of the deflection correction elastic member are connected to the first connecting member and the second connecting member, respectively;
wherein the vibration generator is configured to provide a vibration environment for a vibration test, the test chamber is configured to provide a test specimen with temperature, humidity, a low-pressure environment, and a high-pressure environment, the test platform is disposed in the test chamber and is connected to the first end of the transition head extending into the test chamber, and the test platform is configured to carry the test specimen.

11. The four-integrated vibration test system according to claim 10, wherein each sliding channel of the plurality of sliding channels is provided with a plurality of symmetrically distributed deflection correction assemblies.

12. The four-integrated vibration test system according to claim 10, wherein the vibration test coupling device further comprises a support connecting ring, wherein the test chamber is provided with a through-hole for insertion of the transition head, the support connecting ring is connected at the through-hole, the transition head is slidably inserted into the support connecting ring, and the part of the limiting insert plate extending out of the corresponding sliding channel is connected to the support connecting ring.

13. The four-integrated vibration test system according to claim 12, wherein the vibration test coupling device further comprises a sealing assembly, wherein the sealing assembly comprises a sealing member, and the sealing member is sleeved on the transition head and is configured to seal a gap between the transition head and the support connecting ring.

14. The four-integrated vibration test system according to claim 13, wherein the sealing assembly further comprises a fixing ring, the fixing ring is connected to a side of the support connecting ring facing away from the limiting insert plate, and the sealing member is sandwiched between an inner side of the fixing ring and an outer side of the transition head.

15. The four-integrated vibration test system according to claim 14, wherein the limiting insert plate comprises an insertion portion and a connecting portion, the insertion portion is inserted into the corresponding sliding channel and is adapted to a shape of the corresponding sliding channel, the connecting portion is disposed outside the corresponding sliding channel and extends in a direction away from the adjustment airbag, and the connecting portion is connected to the support connecting ring.

16. The four-integrated vibration test system according to claim 15, wherein each of the plurality of sliding channels is a sector-shaped notch opened on the transition head, and the insertion portion is a triangle cooperating with the sector-shaped notch.

17. The four-integrated vibration test system according to claim 12, wherein a threaded connecting hole is opened at the through-hole of the test chamber, and the support connecting ring is provided with a double-ended countersunk hole corresponding to the threaded connecting hole.
